(19) United States
(12) Patent Application Publication
(10) Pub. No.: US 2012/0042318 A1
(43) Pub. Date: Feb. 16, 2012

(54) AUTOMATIC PLANNING OF SERVICE REQUESTS

(75) Inventors: CHRISTOPHER HOANG DOAN, Austin, TX (US); Kathleen Harlow, Austin, TX (US); Puthukode G. Ramachandran, Austin, TX (US)

(73) Assignee: International Business Machines Corporation, Armonk, NY (US)

(21) Appl. No.: 12/853,935

(22) Filed: Aug. 10, 2010

(51) Int. Cl. G06F 9/46

(52) U.S. Cl. 718/103; 718/102

(57) ABSTRACT

A method, system, and computer usable program product for automatic planning of service requests are provided in the illustrative embodiments. At an application executing in a computer, information is located in a ticket corresponding to the service request, the information being usable for categorizing the ticket. Using the information, a set of records is selected from a ticket history repository, the set of records including data representing a set of tickets processed before the ticket. A second ticket in the set of tickets includes information corresponding to the information in the ticket being processed. A category of the second ticket is selected as a suggested category for the ticket. A priority associated with the suggested category is identified. The suggested category and the priority are recommended for the ticket.

### BACKGROUND OF THE INVENTION

1. Field of the Invention

The present invention relates generally to an improved data processing system, and in particular, to a computer implemented method for managing service requests in a helpdesk environment. More particularly, the present invention relates to a computer implemented method, system, and computer usable program code for automatic planning of service requests in a helpdesk environment.

2. Description of the Related Art

Helpdesks are systems that receive requests for services. For example, a helpdesk application may allow users to enter requests for product upgrade, report bugs in software application products, or request a service. Examples of services that may be requested may include services of an information technology (IT) professional, scheduling a maintenance operation, and reconfiguration of a data processing system.

Service requests are entered into a helpdesk application as a ticket. Generally, a ticket contains some description of the problem and/or the service being requested. A ticket also includes information sufficient to identify the requestor of the service, such as a client identifier of a client of the provider of the helpdesk application.

Presently, a person, such as a helpdesk associate, has to determine what to do with a ticket. The person has to then plan the handling of the ticket.

### SUMMARY OF THE INVENTION

The illustrative embodiments provide a method, system, and computer usable program product for automatic planning of service requests. An embodiment locates, at an application executing in a computer, information in a ticket corresponding to the service request, the information being usable for categorizing the ticket. The embodiment selects using the information, from a ticket history repository, a set of records, the set of records including data representing a set of tickets processed before the ticket, a second ticket in the set of tickets including second information corresponding to the information. The embodiment selects a category of the second ticket as a suggested category for the ticket. The embodiment identifies a priority associated with the suggested category. The embodiment recommends the suggested category and the priority for the ticket.

### BRIEF DESCRIPTION OF THE DRAWINGS

The novel features believed characteristic of the invention are set forth in the appended claims. The invention itself; however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the illustrative embodiments may be implemented;

FIG. 2 depicts a block diagram of a data processing system in which the illustrative embodiments may be implemented;

FIG. 3 depicts a block diagram of a service planning application in accordance with an illustrative embodiment;

FIG. 4 depicts a block diagram of example components of a service planning application in accordance with an illustrative embodiment;

FIG. 5 depicts a flowchart of an example process of automatic planning of service requests in accordance with an illustrative embodiment; and

FIG. 6 depicts a flowchart of an example process of translating words or phrases from a ticket for automatic planning of service requests in accordance with an illustrative embodiment.

### DETAILED DESCRIPTION OF THE PREFERRED EMBODIMENT

The invention recognizes that manual component in the handling of service requests is expensive, inefficient, and error prone. For example, different persons may handle the same ticket differently, causing different actions to be taken with respect to the ticket, if not causing different results. Furthermore, one person may determine that the ticket belongs to one category of service requests whereas another person may categorize the ticket into a different category. Different persons may also prioritize a ticket differently.

A category of service request is a classification of the service request. Categorization of a ticket is the process of assigning a category to the ticket. The categories for the categorization may be created in any manner within the scope of the invention. For example, one method of categorizing service requests may have to do with an assessment of the severity of the problem being reported. Accordingly, for this example, service requests and their corresponding tickets may be categorized according to the problem's degree of impact, such as into example high impact, medium impact, or low categories. Other categories may be according to different levels of support being offered. Another categorization model may utilize categories formed on the basis of directness or indirectness of the relationship of the problem and the product being supported.

A priority of a service request and the corresponding ticket is an indication of urgency associated with the service request. Prioritization of a ticket is a process of assigning a priority to the ticket. Priority of a service request may be determined by any method or selection process within the scope of the invention. For example, a service request for a problem that causes a computer to become inoperative may be prioritized higher than another service request for a problem that causes degradation in the performance of a computer. As another example, a service request from a client who has purchased a premium level of support services may be prioritized higher than a service request from another client who has purchased a basic level of support services. As another example, service requests for problems causing financial losses may be prioritized higher than problems causing inconvenience.

The illustrative embodiments used to describe the invention generally address and solve the above-described problems and other problems related to currently used methods of handling service requests. The illustrative embodiments of the invention provide a method, computer usable program product, and data processing system for automatically planning actions related to service requests, including categorization and prioritization of the tickets.

An embodiment of the invention also enables routing of the tickets to appropriate personnel or systems. An embodiment may automatically configure a workflow with actions to resolve a ticket. For example, an embodiment may automatically schedule time on a service personnel's calendar, reserve the resources necessary for resolving the ticket, or alter a ticket queue to accommodate the ticket.

An embodiment may also facilitate taking follow-up actions on the tickets. For example, despite assigning suitable category and priority to a ticket, if the ticket cannot be scheduled for resolution within the requirements of a service level agreement (SLA), the embodiment may escalate the ticket such that the ticket can preempt another ticket, or a supervisor is notified to coordinate communication with the affected client.

The illustrative embodiments are described with respect to data, data structures, and identifiers only as examples. Such descriptions are not intended to be limiting on the invention. For example, an illustrative embodiment described with respect to a ticket data structure may be implemented using a combination of several pieces of information from different sources, in a similar manner within the scope of the invention.

Furthermore, the illustrative embodiments may be implemented with respect to any type of data processing system. For example, an illustrative embodiment may be implemented with respect to any type of client system, server system, platform, or a combination thereof.

The illustrative embodiments are further described with respect to certain parameters, attributes, and configurations only as examples. Such descriptions are not intended to be limiting on the invention. For example, an illustrative embodiment described with respect to numeric attribute may be implemented using an alphanumeric attribute, a symbolic attribute, or a combination thereof, in a similar manner within the scope of the invention.

An application implementing an embodiment may take the form of data objects, code objects, encapsulated instructions, application fragments, drivers, routines, services, systems—including basic I/O system (BIOS), and other types of software implementations available in a data processing environment. For example, Java® Virtual Machine (JVM®), Java® object, an Enterprise Java Bean (EJB®), a servlet, or an applet may be manifestations of an application with respect to which, within which, or using which, the invention may be implemented. (Java, JVM, EJB, and other Java related terminologies are registered trademarks of Sun Microsystems, Inc. in the United States and other countries.)

An illustrative embodiment may be implemented in hardware, software, or a combination thereof. The examples in this disclosure are used only for the clarity of the description and are not limiting on the illustrative embodiments. Additional or different information, data, operations, actions, tasks, activities, and manipulations will be conceivable from this disclosure for similar purpose and the same are contemplated within the scope of the illustrative embodiments.

The illustrative embodiments are described using specific code, file systems, designs, architectures, layouts, schematics, and tools only as examples and are not limiting on the illustrative embodiments. Furthermore, the illustrative embodiments are described in some instances using particular data processing environments, such as a helpdesk environment, only as an example for the clarity of the description. The illustrative embodiments may be used in conjunction with other comparable or similarly purposed structures, systems, applications, or architectures.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

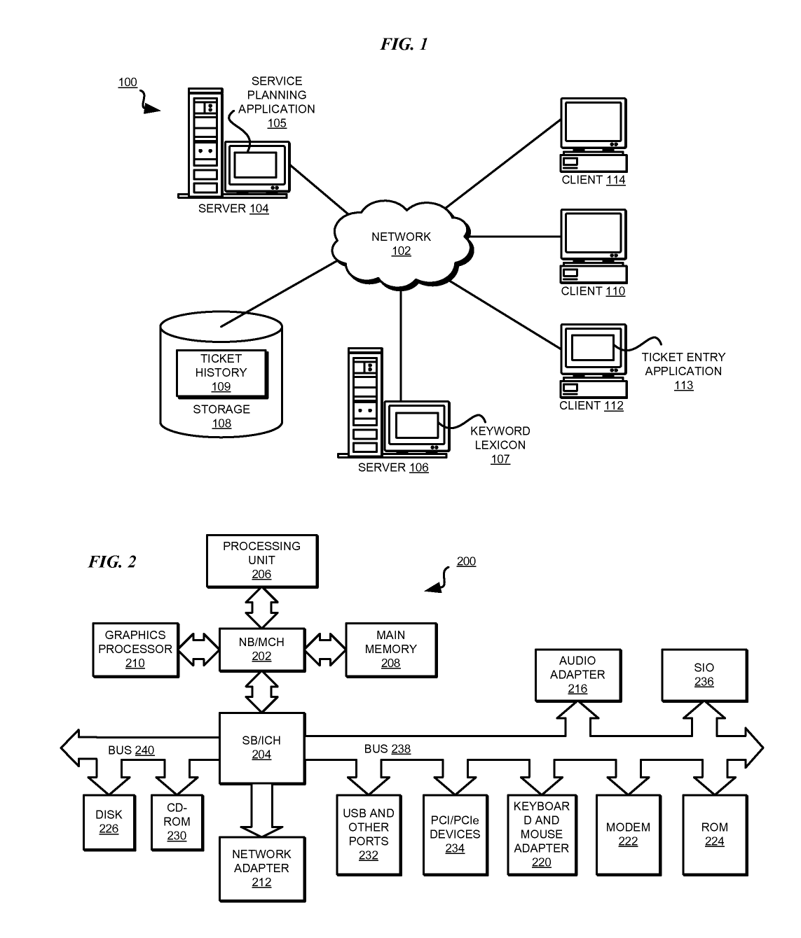

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Server 104 may include service planning application 105. Service planning application 105 may be an application for automatic planning of service requests according to an embodiment described herein.

Server 106 may include keyword lexicon 107. Keyword lexicon 107 may provide alternative phrases for a concept, a listing of words or keywords, translation of words from one language to another, or a combination thereof.

Storage 108 may include ticket history 109. Ticket history 109 may be a historic record of tickets entered into a helpdesk system, and resolved or otherwise disposed off in the past. Client 112 may include ticket entry application 113. Ticket entry application 113 may be a helpdesk application for submitting requests for service.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client server environment in which the illustrative embodiments may be implemented. A client server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations. In some configurations, processing unit 206 may include NB/MCH 202 or parts thereof.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). In some configurations, ROM 224 may be an Electrically Erasable Programmable Read-Only Memory (EEPROM) or any other similarly usable device. Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java is a trademark of Sun Microsystems, Inc., in the United States and other countries).

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

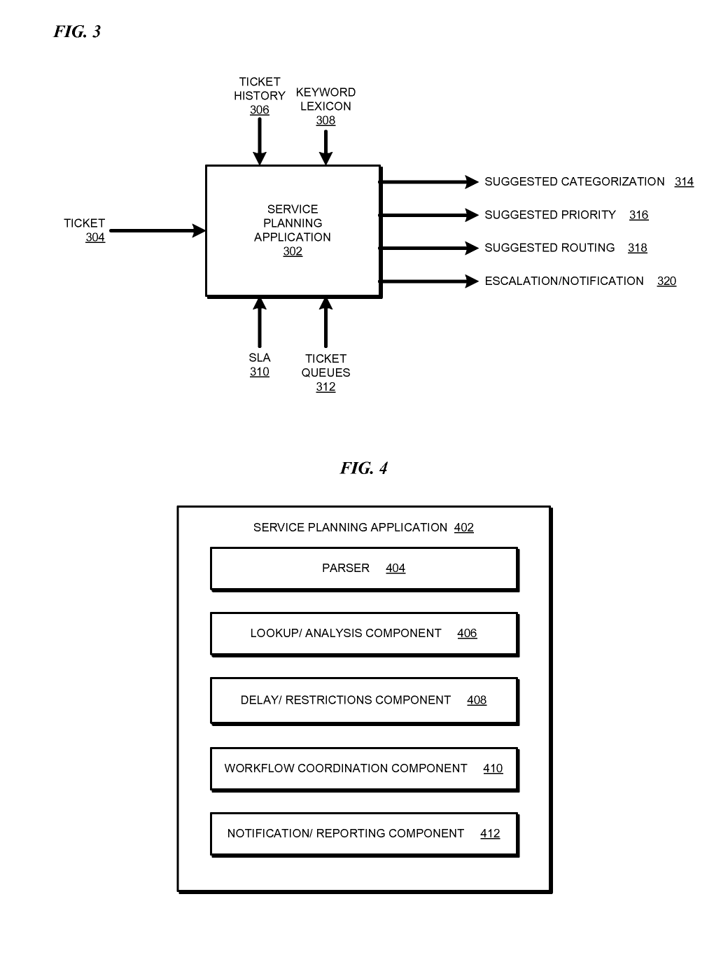

With reference to FIG. 3, this figure depicts a block diagram of a service planning application in accordance with an illustrative embodiment. Service planning application 302 may be implemented as service planning application 105 in FIG. 1.

Service planning application 302 accepts ticket 304 as input. Ticket 304 may be information of a service request in any form without limitation.

Ticket history 306 may be similar to ticket history 109 in FIG. 1. Ticket history 306 provides records of past tickets, such as upon query from service planning application 302. A record of a past ticket includes not just the information about the corresponding service request, such as the text of the summary or detail of the request, but also information about the resolution of the ticket. The information about the resolution of the ticket may include the category and priority that was assigned to the ticket.

The resolution information may also optionally include the time intervals between various actions taken with respect to ticket since the ticket was received until the ticket was closed. The resolution information may also optionally include information about actions taken, dependent actions, and actions on which these actions were dependent.

Similarly, the resolution information may also optionally include information about actors—persons or systems who acted upon the ticket, dependent actors, and actors on which these actors were dependent. For example, one person working on one part of the ticket may be dependent on another person working on another part of the ticket, or a person working on the ticket may have required approval from a supervisor before the person could proceed with an action. As another example, an application that restarted during an action as a part of the work on a ticket may have been dependent upon another application restarting or providing data for that action to complete.

Keyword lexicon 308 may be similar to keyword lexicon 107 in FIG. 1. Keyword lexicon 308 may provide information usable for determining one or more categories that may be assigned to ticket 304. For example, in one embodiment, keyword lexicon 308 may provide a list of words or phrases that may be searched for by parsing the text of the service requested in ticket 304. Using any matching words or phrases found in ticket 304, the records provided by ticket history 306 may be searched for those matching words or phrases. Past tickets containing some or all of those matching words or phrases may be further analyzed to determine the category and priority assigned to those past tickets.

In another example embodiment, keyword lexicon 308 may provide alternative words or phrases for words or phrases found in ticket 304. A search of records from ticket history 306 can proceed using the words or phrases from ticket 304, alternative words or phrases provided by keyword lexicon 308, or a combination thereof, to find matching words or phrases. Past tickets containing some or all of those words or phrases may be further analyzed to determine the category and priority assigned to those past tickets.

In another embodiment, keyword lexicon 308 may provide words or phrases in another language for words or phrases found in ticket 304. A search of records from ticket history 306 can proceed using the words or phrases from ticket 304, words or phrases in the other language provided by keyword lexicon 308, or a combination thereof, to find matching words or phrases. Past tickets containing some or all of those words or phrases may be further analyzed to determine the category and priority assigned to those past tickets. Note that more than one ticket history 306 may participate to provide records of past tickets. For example, one instance of ticket history 306 may provide records in a first language, and another instance in another language.

Service planning application 302 may also accept SLA 310 as input. Service planning application 302 may derive the conditions, restrictions, or rules of SLA 310, or receive them in a form usable within application 302 from a source of SLA 310. For example, an instance of SLA 310 may require that a ticket of the highest configured priority must be closed within twenty four hours, and a ticket must be closed within seven days of opening regardless of the priority assigned to the ticket. Accordingly, service planning application 302 may derive the twenty-four hours and seven days as the restricting parameters from SLA 310 for prioritizing and routing ticket 304. Many other types of information in SLA 310 usable in this manner will be conceivable from this disclosure to those of ordinary skill in the art, and the same are contemplated within the scope of the invention.

Service planning application 302 may also accept information about ticket queues 312. For example, an organization may maintain different queues for sequencing or scheduling tickets. A ticket may be queued to a particular queue based on any criterion, including but not limited to the category or priority of the ticket. For example, one queue may hold the tickets for one supported application, and another for another application. As another example, one queue may be for one service personnel and another for another personnel. As another example, one queue may be for one client and another for another client. Many other ways of queuing tickets for resolution will be conceivable from this disclosure to those of ordinary skill in the art, and the same are contemplated within the scope of the invention.

Based on the category and priority assigned to ticket 304, service planning application 302 may attempt to route ticket 304 to a ticket queue such that the relevant restrictions from SLA 310 are satisfied. Accordingly, service planning application 302 outputs suggested categorization 314 and suggested priority 316 for ticket 304.

Service planning application 302 may also output suggested routing 318. In one embodiment, suggested routing 318 may indicate a queue from ticket queues 312 where ticket 304 should be queued. In another embodiment, suggested routing 318 may indicate one or more actors to whom ticket 304 should be assigned. In another embodiment, suggested routing 318 may indicate a workflow where processing of ticket 304 should be inserted. Service planning application 302 may additionally insert all or part of the processing of ticket 304 into one or more workflows.

Should processing of ticket 304 not meet the conditions or restrictions of SLA 310, service planning application 302 may perform escalation or notification 320. For example, service planning application 302 may notify a client account manager that ticket 304 will likely not be closed according to SLA 310. As another example, service planning application 302 may override the assigned priority of ticket 304 and place or escalate ticket 304 ahead of certain other tickets.

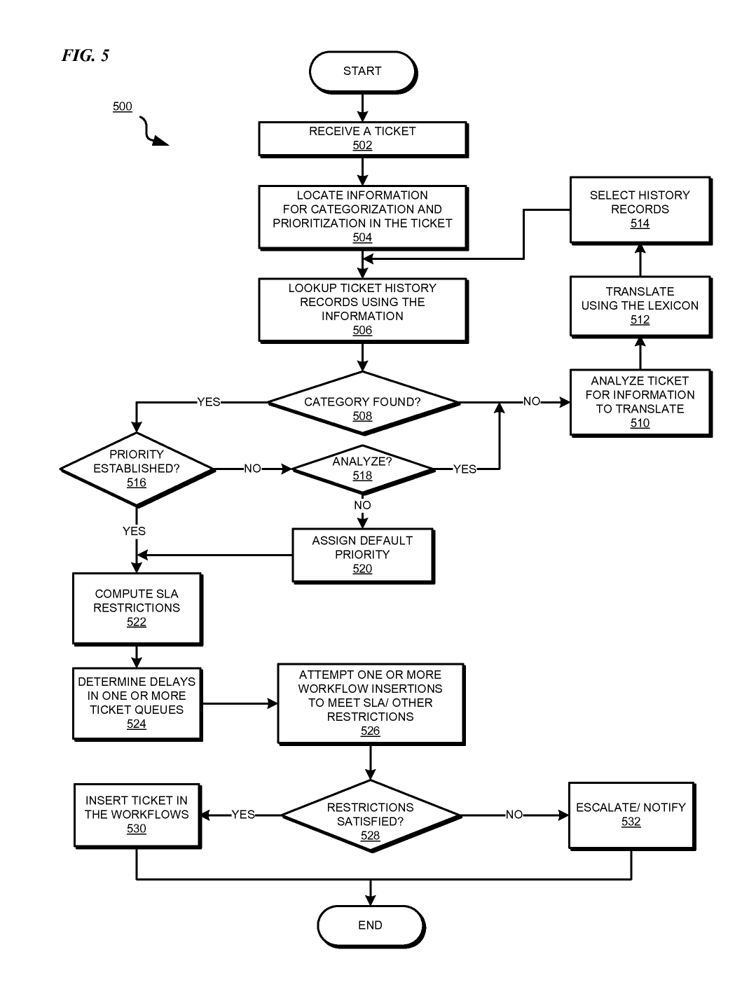

With reference to FIG. 4, this figure depicts a block diagram of example components of a service planning application in accordance with an illustrative embodiment. Service planning application 402 may be implemented as service planning application 302 in FIG. 3.

Parser 404 may be a component that parses or searches a ticket's data, such as to identify words or phrases that can be used for categorizing and prioritizing the ticket as described above. Lookup and analysis component 406 may perform the lookup of a keyword lexicon to identify a set of words or phrases that are related to the words or phrases identified by the parser. Component 406 may analyze the records from a ticket history. The analysis may be to determine whether one or more ticket having similar words or phrases, as resulting from the lookup, have been closed or worked on in the past. Lookup and analysis component 406 may be implemented as separate components within the scope of the invention.

Delay and restrictions component 408 may compute a delay in processing the ticket, such as by considering the existing workload in the various ticket queues where the ticket would be scheduled. Component 408 may also identify, receive, or determine restrictions and/or conditions of one or more relevant SLAs. Component 408 may consider the restrictions and/or conditions of the SLAs in making the delay determination as described above. Delay and restrictions component 408 may be implemented as separate components within the scope of the invention.

Workflow coordination component 410 may coordinate the processing actions of a ticket into one or more workflows. For example, component 410 may communicate with a scheduler or calendaring application to schedule a processing action for a ticket.

Notification and reporting component 412 may perform reporting activities. For example, component 412 may edit a log file as an event of an action completion is received from a workflow. As another example, component 412 may email a reminder to an actor of an upcoming action on a ticket. As another example, component 412 may notify a supervisor when an action is not completed within a planned timeframe.

Component 412 may also escalate a ticket. For example, component 412 may increase the priority of a ticket to close the ticket within SLA parameters. As another example, component 412 may escalate a ticket resolution issue to a supervisor, for example, to request more resources for the ticket resolution. Escalation may be implemented as a separate component within the scope of the invention. Generally, the invention does not limit how the various functions of an embodiment are implemented in any given implementation.

With reference to FIG. 5, this figure depicts a flowchart of an example process of automatic planning of service requests in accordance with an illustrative embodiment. Process 500 may be implemented in service planning application 402 in FIG. 4.

Process 500 begins by receiving the information of a ticket (step 502). Process 500 locates information in the ticket that is usable for categorization and prioritization of the ticket (step 504). Process 500 looks up ticket history records using the information of step 504 (step 506).

Process 500 determines whether a category has been found from one or more past tickets having information corresponding to information of step 504 (step 508). If a category is not identified from the ticket history records (“No” path of step 508), process 500 analyzes the ticket for information to translate, such as to different words in the same or different language, (step 510).

Process 500 translates the information using a keyword lexicon (step 512). Process 500 selects appropriate history records to search for the translated information (step 514). Process 500 returns to step 506. In an alternate embodiment, steps 510, 512, and 514 may be performed in combination with step 504 and the lookup of step 506 may be performed with the combined information.

If process 500 determines that a category has been found (“Yes” path of step 508), process 500 determines whether a priority of the ticket can be established in a manner similar to the matching past tickets (step 516). If a priority of the ticket cannot be established (“No” path of step 516), process 500 may further analyze the ticket history records to determine possible priorities that can be assigned to the ticket (step 518). If further analysis is to be performed (“Yes” path of step 518), process 500 may return to step 510. If further analysis is not to be performed (“No” path of step 518), process 500 assigns the ticket a default priority (step 520).

Following step 520, or if a priority has been established for the ticket (“Yes” Path of step 516), process 500 computes any SLA restrictions that may affect the processing of the ticket (step 522). Process 500 determines delays in one or more ticket queues where the ticket is to be routed (step 524). Process 500 may further attempt to insert the ticket or an action there for into one or more workflows to meet the SLA restrictions or restrictions received from another source (step 526).

Process 500 determines whether the workflows with the ticket or actions inserted therein will satisfy the restrictions (step 528). If the restrictions will be satisfied (“Yes” path of step 528), process 500 inserts the ticket or an action there for into a workflow (step 530) and ends thereafter. If a restriction will not be satisfied (“No” path of step 528), process 500 may escalate the ticket or notify someone (step 532) and end thereafter.

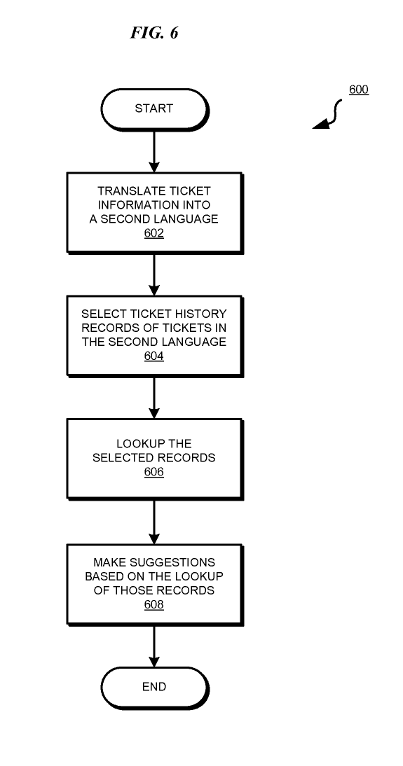

With reference to FIG. 6, this figure depicts a flowchart of an example process of translating words or phrases from a ticket for automatic planning of service requests in accordance with an illustrative embodiment. Process 600 may be implemented in service planning application 402 in FIG. 4. Process 600 may be used in place of, or in conjunction with steps 504, 510, 512, and 514 of process 500 in FIG. 5.

Process 600 begins by translating information from a ticket into a second language (step 602). For example, process 600 may translate certain words or phrases parsed from the ticket as describing the problem, the service, or a combination thereof, identified in the ticket. Process 600 may translate in step 602 by using a keyword lexicon that provides the translations of the parsed words or phrases into the second language.

Process 600 selects records of tickets in the second language from a ticket history (step 604). For example, an instance of a ticket history repository may provide records of tickets in a particular language. Process 600 may request those records that may include the same or similar translated words or phrases.

Process 600 looks up the selected record to determine the category and/or the priority of the past tickets in those records (step 606). Process 600 then makes the suggestions using the lookup of those records (step 608), such as by using process 500 in FIG. 5. Process 600 ends thereafter.

The components in the block diagrams and the steps in the flowcharts described above are described only as examples. The components and the steps have been selected for the clarity of the description and are not limiting on the illustrative embodiments of the invention. For example, a particular implementation may combine, omit, further subdivide, modify, augment, reduce, or implement alternatively, any of the components or steps without departing from the scope of the illustrative embodiments. Furthermore, the steps of the processes described above may be performed in a different order within the scope of the invention.

Thus, a computer implemented method, apparatus, and computer program product are provided in the illustrative embodiments for automatic planning of service requests. Using an embodiment of the invention, a service request can be categorized, prioritized, and even routed automatically for processing. An embodiment may further assist in ensuring compliance with an SLA in processing a ticket for a service request. An embodiment may also provide automatic service request ticket processing in multiple languages.

The invention can take the form of an entirely software embodiment, or an embodiment containing both hardware and software elements. In a preferred embodiment, the invention is implemented in software or program code, which includes but is not limited to firmware, resident software, and microcode.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code. A client data processing system may download that computer usable code, such as for storing on a data storage medium associated with the client data processing system, or for using in the client data processing system. The server data processing system may similarly upload computer usable code from the client data processing system. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for automatic planning of a service request, comprising:
locating, at an application executing in a computer, information in a ticket corresponding to the service request, the information being usable for categorizing the ticket;
selecting using the information, from a ticket history repository, a set of records, the set of records including data representing a set of tickets processed before the ticket, a second ticket in the set of tickets including second information corresponding to the information;
selecting a category of the second ticket as a suggested category for the ticket;
identifying a priority associated with the suggested category; and
recommending the suggested category and the priority for the ticket.

2. The computer implemented method of claim 1, further comprising:
computing a restriction imposed by a service level agreement (SLA);
determining whether the suggested category and priority will allow the ticket to be processed while satisfying the restriction; and
scheduling the ticket in a queue, responsive to the restriction being satisfied.

3. The computer implemented method of claim 2, wherein the queue is selected from a plurality of ticket queues, and wherein scheduling the ticket in a second queue in the plurality of ticket queues fails to satisfy the restriction.

4. The computer implemented method of claim 3, wherein the queue is more than one queues in the plurality of ticket queues, and wherein each of the more than one queues receives an action for resolving the ticket.

5. The computer implemented method of claim 2, further comprising:
escalating, responsive to the restriction not being satisfied, the ticket.

6. The computer implemented method of claim 5, wherein the escalating is accomplished by adjusting the priority of the ticket such that the ticket supersedes another ticket in the queue thereby allowing the processing of the ticket to complete while satisfying the restriction.

7. The computer implemented method of claim 1, further comprising:
inserting an action for processing the ticket into a workflow.

8. A computer usable program product comprising a computer usable storage medium including computer usable code for automatic planning of a service request, the computer usable code comprising:
computer usable code for locating, at an application executing in a computer, information in a ticket corresponding to the service request, the information being usable for categorizing the ticket;
computer usable code for selecting using the information, from a ticket history repository, a set of records, the set of records including data representing a set of tickets processed before the ticket, a second ticket in the set of tickets including second information corresponding to the information;
computer usable code for selecting a category of the second ticket as a suggested category for the ticket;
computer usable code for identifying a priority associated with the suggested category; and
computer usable code for recommending the suggested category and the priority for the ticket.

9. The computer usable program product of claim 8, further comprising:
computer usable code for computing a restriction imposed by a service level agreement (SLA);
computer usable code for determining whether the suggested category and priority will allow the ticket to be processed while satisfying the restriction; and
computer usable code for scheduling the ticket in a queue, responsive to the restriction being satisfied.

10. The computer usable program product of claim 9, wherein the queue is selected from a plurality of ticket queues, and wherein scheduling the ticket in a second queue in the plurality of ticket queues fails to satisfy the restriction.

11. The computer usable program product of claim 10, wherein the queue is more than one queues in the plurality of ticket queues, and wherein each of the more than one queues receives an action for resolving the ticket.

12. The computer usable program product of claim 9, further comprising:
computer usable code for escalating, responsive to the restriction not being satisfied, the ticket.

13. The computer usable program product of claim 12, wherein the escalating is accomplished by adjusting the priority of the ticket such that the ticket supersedes another ticket in the queue thereby allowing the processing of the ticket to complete while satisfying the restriction.

14. The computer usable program product of claim 8, further comprising:
computer usable code for inserting an action for processing the ticket into a workflow.

15. The computer usable program product of claim 8, wherein the computer usable code is stored in a computer readable storage medium in a data processing system, and wherein the computer usable code is transferred over a network from a remote data processing system.

16. The computer usable program product of claim 8, wherein the computer usable code is stored in a computer readable storage medium in a server data processing system, and wherein the computer usable code is downloaded over a network to a remote data processing system for use in a computer readable storage medium associated with the remote data processing system.

17. A data processing system for automatic planning of a service request, the data processing system comprising:
a storage device including a storage medium, wherein the storage device stores computer usable program code; and
a processor, wherein the processor executes the computer usable program code, and wherein the computer usable program code comprises:
computer usable code for locating, at an application executing in a computer, information in a ticket corresponding to the service request, the information being usable for categorizing the ticket;
computer usable code for selecting using the information, from a ticket history repository, a set of records, the set of records including data representing a set of tickets processed before the ticket, a second ticket in the set of tickets including second information corresponding to the information;
computer usable code for selecting a category of the second ticket as a suggested category for the ticket;
computer usable code for identifying a priority associated with the suggested category; and
computer usable code for recommending the suggested category and the priority for the ticket.

18. The data processing system of claim 17, further comprising:
computer usable code for computing a restriction imposed by a service level agreement (SLA);
computer usable code for determining whether the suggested category and priority will allow the ticket to be processed while satisfying the restriction; and
computer usable code for scheduling the ticket in a queue, responsive to the restriction being satisfied.

19. The data processing system of claim 18, wherein the queue is selected from a plurality of ticket queues, and wherein scheduling the ticket in a second queue in the plurality of ticket queues fails to satisfy the restriction.

20. The data processing system of claim 19, wherein the queue is more than one queues in the plurality of ticket queues, and wherein each of the more than one queues receives an action for resolving the ticket.
